(19) United States
(12) Patent Application Publication
(10) Pub. No.: US 2008/0271795 A1
(43) Pub. Date: Nov. 6, 2008

(54) Process and Device for Producing Colored Streams of Fluid for a Hot Water Fitting

(76) Inventor: Reiner Buhlmann, Grossbardau (DE)

Correspondence Address: MCGLEW & TUTTLE, PC, P.O. BOX 9227, SCARBOROUGH STATION, SCARBOROUGH, NY, 10510-9227, US

(21) Appl. No.: 10/599,579

(22) PCT Filed: Apr. 1, 2005
(86) PCT No.: PCT/DE05/00579

§ 371 Date: Oct. 2, 2006

(30) Foreign Application Priority Data
Apr. 13, 2004 (DE) 10 2004 017 736.8

(51) Int. Cl. F16K 37/00

(52) U.S. Cl. 137/551

(57) ABSTRACT

The object of the invention is to give a coloured, temperature-dependent appearance to the water flowing out of a hot-water fitting. For that purpose, three temperature ranges are formed and a colour is associated with each of the temperature ranges. The three ranges correspond to too cold, too hot and desired temperature ranges. A lever (4) is actuated to cause a water jet (20) to flow out of the fitting. Depending on the position of the lever (4), only cold water, only hot water or mixed proportions of cold and hot water flow into the mixing chamber (7). Depending on the temperature measured in the mixing chamber (7), a control block (13) drives diodes (17) arranged at the outlet of the hot-water fitting and having a colour which corresponds to the temperature range in question, causing the diodes to emit light. The water jet (20) flowing past the diodes (17) is illuminated with said colour. The user of the fitting can recognise the water temperature from the coloured appearance of the water jet (20) and if necessary correct it by actuating the lever (4).

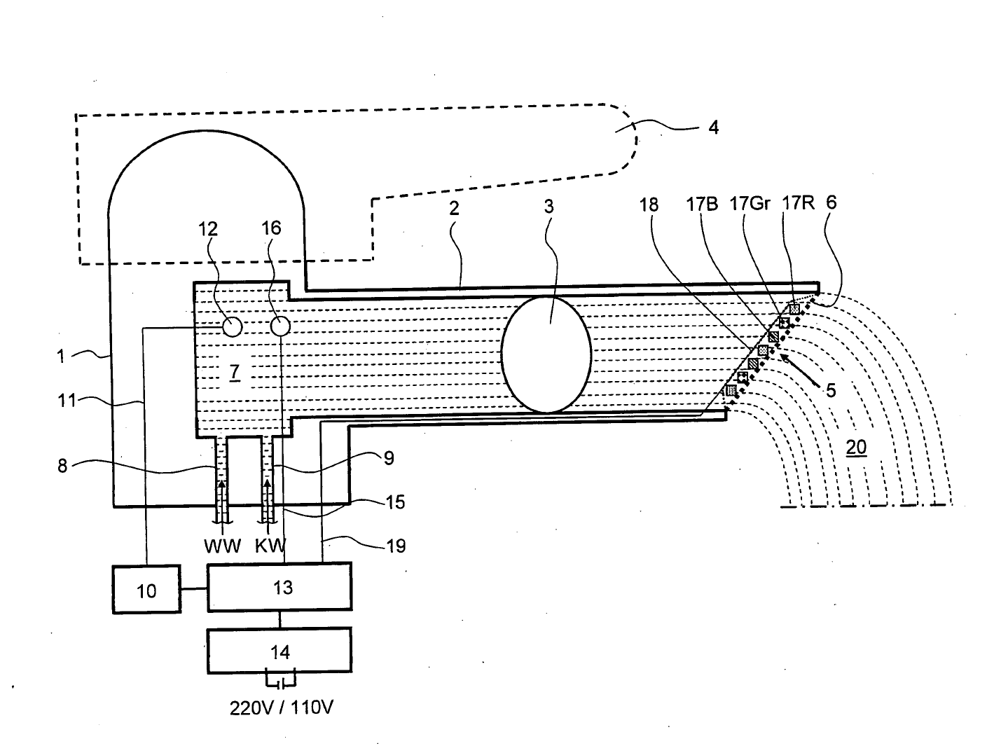

### CROSS REFERENCE TO RELATED APPLICATIONS

This application is a United States National Phase application of International Application PCT/DE2005/000579 and claims the benefit of priority under 35 U.S.C. § 119 of German Patent Application DE 10 2004 017 736.8 filed Apr. 13, 2004, the entire contents of which are incorporated herein by reference.

### FIELD OF THE INVENTION

The present invention pertains to a process for producing colored streams of fluid and a device for the application of the process.

### BACKGROUND OF THE INVENTION

Giving a white or colored appearance to the streams of fluid escaping from water outlet fittings, fountains, artificial waterfalls and the like for achieving optical effects is known. To this end, light sources are used, whose light waves are fed into the medium. The intended light effects are achieved by the impacting of the light waves on the edge of the outflowing water jet and onto a medium, such as, for example, a wash basin. The light effect over the entire length of the water jet is produced by the reflection of the directed light waves within the water jet, as it is well known of fiberglass cables. Light, color and light effect are defined as visible color signals that are perceived by the normal-sighted eye in the fluid or at the site of the impact of the fluid.

Thus, a fluid nozzle, which is provided with an illumination source for achieving a white or colored water jet, is known from the Patent EP 0181 896 B2. The illumination source comprises a lighting means, which in 14 different embodiments is located either directly at the outlet opening of the fluid or at a site at a distance therefrom. So that as little illuminating power as possible is lost in the dispersion of the light up to the outlet opening of the fluid, means are provided for low-loss guiding of the light. The lighting means are placed within the water outlet fitting, fountain or artificial waterfall either outside the supplied fluid or in the fluid itself. It is thus achieved by suitable means that the fluid does not come into contact with the lighting means and the electrically conductive parts. In order to achieve a change in the color of the water jet, a rotatable prism or an optical grid can be placed in front of the illumination source. By means of the present invention, a water jet can be effectively lit up in bold colors.

Another white or colored, illuminating water jet for an ornamental fountain is known from the Patent US 6 393 192 B1. The water circulates constantly in the circuit from a basin via a system of pipelines to an outlet pipe placed higher, from where, as a free water jet, it again flows back into the basin. The motion of the water is produced by means of a pump. The light effect of the water is produced by means of a light source located outside of the water circuit. A fiberglass cable is led from this light source in a watertight manner into the system of pipelines up to the outlet pipe. It ends just before the outlet opening, where the light beam passes into the water.

Furthermore, an artificial waterfall, in which light from a light source is guided to the lower edge of a water outlet opening by means of a fiber optic cable, has become known from the Patent US 6 375 342 B1. In this case, the fiber optic cable is arranged such that the illuminating ends of the individual fibers are located in a certain association with one another under the water outlet.

Moreover, a light shower for use in showers has become known from the Utility Model DE 299 00 790 U1 . The shower head is provided on the inside with a light source, which lights up the jets of the exiting water by means of a dispersing disk and the light is disseminated into the water jets.

With these prior-art solutions acknowledged above, an effective effect is achieved by means of the illuminating water jets which is perceived by the observer as beautiful, calming and aesthetic.

Fittings, which are actuated by means of an actuating element or by means of a contact-free involvement of a person, make recognition of individually set water temperature ranges impossible, since the medium emerges only in case of detection by a person and thus a presetting is necessary. This requires a trying out of the operating temperature by using and holds the dangers of scalding by emerging hot water or, in the reverse case, of reducing a person's body temperature due to too cold medium.

When preparing a bath, there is often the problem that the manually set water temperature does not remain constant over the entire intake duration. The determination of the temperature is sensed at certain intervals one after another by the water admitted into the bathtub and by the water intake. An adjustment is then made, if necessary. In order to cut down on the hand contact needed for the determination of the water temperature, it is known to use water outlet fittings equipped with temperature indicators. If the inlet temperature shows a deviation from the set value, an adjustment is made manually.

Furthermore, a single-lever fitting, which is equipped with an actuating element for the automatic setting of a special mixing ratio of cold and hot water for the immediate preparation of water of a certain temperature, has become known from Unexamined Published Patent Application DE 102 19 171 A1. Such a fitting is particularly suitable for public facilities, where different users can wash their hands, without the water temperature having to be reset each time by adjusting and testing. Actuating elements for regulating the water temperature can be angle of inclination pickups and/or acceleration pickups that are functionally connected to the mixing lever. The desired water temperature is set at the beginning. All the subsequent users will then have water of a comfortable temperature for hand washing. Thus, the water consumption is lowered, because an adjustment of the water temperature, in which a certain quantity of water runs off in a useless manner, is no longer necessary. Moreover, the risk of scalding the hands because of a mixing ratio being set too hot is avoided. If the fitting shall discharge water at a different temperature, this fitting is reset.

A water jet illuminator, which comprises a beam former that can be screwed at the output of a hot water fitting and thus extends the water outlet channel of the fitting, is already known from the publication DE 201 02 857 U1. Light-emitting diodes of various colors are arranged in the interior of the beam former. They are enclosed by a tubular light guide, which leads, in terms of flow technology according to the perlator, from outside by means of a curvature into the axis of the water jet. Two diodes, which are electrically connected to one another by means of the conductivity of the water, protrude into the through opening of this beam former, as soon as the hot water fitting was opened. A switching means consisting of electronic components, which is supplied with energy by means of a battery, is provided for this purpose. The water temperature is measured by means of a temperature sensor, and the measured result is fed to an electronic analyzer, which, depending on the measured water temperature, switches light-emitting diodes of a certain color or of a different combination of colors on or off. Thus, the present water temperature is signaled to the user of the water faucet after turning on by means of the color of the water jet.

### SUMMARY OF THE INVENTION

The object of the present invention is to create a process and a device for application of the process for a simple way to recognize the temperature of the water flowing out of a hot water outlet fitting fed with hot and cold water by means of a temperature-dependent change in the color of the water jet, on the basis of which, if necessary, a manual adjustment can be made for correction of the water temperature. The device is able to be placed in the hot water outlet opening, such that the freely visible part of the fitting does not have to be enlarged. Furthermore, the light beams coming from the light means shall be fed into the water jet in an as low-loss manner as possible.

This object is accomplished according to the present invention by the process according to claim 1 and the device according to claim 5. This is accomplished in that light-emitting diodes [sic, are? —Tr.Ed.] arranged directly in the area of the water outlet, and the water jet flowing out of the fitting is caused to have a colored appearance by means of the light-emitting diodes in a temperature-dependent manner at fixed temperature stages. A preferred temperature range is determined, [and] the temperatures lying above it and below it form two other ranges. Each of these ranges receives a certain color. In conjunction with the identification of red for hot water and blue for cold water, it is suggested to use red for the upper range and blue for the lower range. A third color is selected for the preferred middle temperature range, which may also be called the desired temperature range.

The process according to the present invention provides that the device switches on with the increase in the pressure in the mixing chamber. This condition is reached with the opening of the water inflow. The temperature of the water located in the mixing chamber is still measured before the discharge from the mixing faucet. This actually present temperature is assigned to the range in question, i.e., “too cold,” “desired temperature range,” or “too hot.” In addition, the lighting means of the color affecting the range is switched on and the user recognizes by the color of the water jet whether or not a correction is necessary. If the water jet lights up in a color that indicates a too cold or too hot temperature, a correction is made by the user by means of an adjustment until the color of the water jet is identical to the desired range of the temperature. This actual condition is indicated by the color in question, which is still achieved in the mixing chamber before the escape of the water from the outlet fitting. After the closing of the fitting, the device is switched off by means of recognizing the drop in pressure. The process is operated with weak current.

The device consists of a pressure switch, by means of which it is switched on and switched off in a pressure-dependent manner. A pressure sensor, which is arranged in the mixing chamber of the fitting, is provided as pressure measuring point. This pressure switch is functionally connected to the control block. With the buildup of the operating pressure in the mixing chamber, the pressure switch switches on the control block. This control block receives signals from the temperature sensor, which is likewise arranged in the mixing chamber, which it recognizes as the temperature of the mixed water. The temperature actually present in the mixing chamber is assigned in the control block to one of the three temperature ranges and lighting means with the color assigned to the range is switched on. These lighting means are diodes, which are arranged in each of the three colors in a sufficient number on a multichip. This multichip is arranged together with the perlator in the outlet opening of the fitting. In this case, the multichip and the perlator form a protection against external effects for the diodes. To guarantee a sufficient permeability of the water, the multichip is provided with openings. The color radiation of the water flowing past the light-emitting diodes at the output of the fitting is continued in the water jet and lights this up in the [sic, color? —Tr.Ed.] in question. For regulating [sic, “Reglung” is an obvious typo for “Regelung”—Tr.Ed.] the water temperature, the user actuates the lever, so that the feed stream of the portions of cold water and hot water are [sic, is—Tr.Ed.] changed. A transformer is provided for supplying the control block and the light-emitting diodes with weak current.

The following advantages are connected with the application of the present invention:
1. No light losses occur by means of introducing the light at the water outlet. A high dispersion of light is achieved.
2. The entire device has a small space requirement, such that it can be placed in a hot water fitting of a standard size.
3. The transformer is arranged under the wash basin, such that it is not visible with its supply line.
4. Emotional comfort effect due to an illumination in the luxus range (AHA effect).
5. Energy-saving effect due to saving of hot water.
6. Prevention of scaldings due to temperatures above 38° C. by children and disabled people/senior citizens/persons with diabetes mellitus.
7. Integration in the field of gerontology/people with skin disability for recreation and meditation.
8. Legionella water hygiene management (prevention of deaths due to formation of Legionella in standing water)>55° C. for compliance with DVGW W 551 and W 552.
9. Color therapy with green (against stress and hectic state).
10. Prevention of cooling off of body parts exposed to cold water, which are felt to be unpleasant.
11. Measurement ofthe water pressure and of the water temperature right at the start of the water channel in the mixing chamber of the fitting, such that a fast startup and response of the device is possible.

An exemplary embodiment of the present invention is shown in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

The only Figure is a schematic block view with diagram showing a control loop and a controlled system view for a single-lever water outlet fitting.

### DESCRIPTION OF THE PREFERRED EMBODIMENTS

Referring to the drawings in particular, the drawing shows the block diagram with a control loop and a controlled system view for a single-lever water outlet fitting. This is referred to simply as fitting below.

In the drawing, the fitting is shown in a simplified manner and schematically in a sectional view. In principle, the fitting comprises the basic body 1 and the outlet pipe 2. The internal diameter 3 of the output pipe 2 is reproduced by means of a circle. The lever 4 for the manual release of the water feed, which is shown in broken lines, is located on the basic body 1. The outlet opening 5 for the water is provided with a perlator (outlet end device—aerator, flow distributor screen) 6. The mixing chamber 7, to which the outlet pipe 2 is connected, is located in the interior of the basic body 1. The two pipelines 8, 9 for the cold water (KW) and the hot water (WW) lead to the mixing chamber 7. The fitting is equipped with a pressure switch 10, which is functionally connected via a pipeline 11 to a pressure sensor 12 arranged in the mixing chamber 7. Furthermore, the fitting includes a controlblock 13 and a transformer 14. The control block 13 is supplied with weak current by means of the transformer 14. From the control block 13, a pipeline 15 leads to a temperature sensor 16 arranged in the mixing chamber 7. A multichip (printed circuit board) 18, equipped with light-emitting diodes (LED), 17 is arranged in front of the outlet opening in the interior of the outlet pipe 2. Red light-emitting diodes 17R, blue light-emitting diodes 17B and green light-emitting diodes 17Gr are used and installed on the printed circuit board 18. These light sources 17 are arranged in the necessary number and the selected colors on the multichip 18 with blue light-emitting diodes 17B, green light-emitting diodes 17Gr and red light-emitting diodes 17R and are switched via the low-voltage line 19, such that a color effect, intended in their appearance, develops in the fluid jet or water stream 20. The number of light-emitting diodes 17 of each color depends on the light intensity of the diodes 17 used and on the overall light intensity that shall be achieved. Instead of blue, green and red light-emitting diodes 17, the RGB-LED, which are available as a new development, may also be used, in which the three colors red, green and blue are available in a component. The multichip 18 equipped with the light-emitting diodes or diode component 17 is integrated into the perlator or outlet 6 and as a set of components is thus protected against external effects. It is also possible to install the color diodes 17 directly in the perlator 6 without the printed circuit board.

For the appearance of the water jet or water stream flowing out of the water outlet fitting, the following three colors are set in a temperature-dependent manner:

for cold water of the range up to circa 18° C.—blue water color
for hot water of the range 19° C. −38° C.—green water color
for hot water of the range over 38° C.—red water color.
These temperature ranges and the color selection are not absolute, they may also be set differently.

The lever 4 is actuated for releasing a water jet water stream 20 from the fitting. Depending on the position of the lever 4, either only cold water, only hot water or proportionately cold and hot water is let into the mixing chamber 7. By means of the pressure sensor 12, the pressure buildup in the mixing chamber 7 is detected. Due to this pressure buildup, the control block 13 is put into operation via the pressure switch 10. In this case, a contact releases the circuit. The control block 13 receives signals from the temperature sensor 16, which it recognizes as the actually present temperature. By means of the control block 13, the light-emitting diodes 17B, 17Gr and 17R of the color determined for the respective temperature range are now lit up on the printed circuit board 18. The desired color is introduced into the fluid. The user of the fitting can recognize the temperature of the water from the colored appearance of the water jet 20 and thus, if necessary, can make a correction by means of actuating the lever 4 at a time before the water is in contact with the hand.

The closing of the water feed is detected as a drop in pressure by the pressure sensor 12 and the device is switched off.

Effective color displays may likewise take place without/with temperature change with the three basic colors red, green and blue, including all mixed color shades.

It is also possible to provide light-emitting diodes 17 of the colors red, yellow and blue and to mix these primary colors additively, so that the colors determined for the respective temperature ranges are formed. To this end, the control block 13 is designed correspondingly.

If the temperature-dependent color change in the water jet is temporarily not needed, it is also possible to produce a color play (display) with the light-emitting diodes 17 in a temperature-independent manner. To this end, a switch can be provided for changing the type of operation.

A fitting thus equipped can be used on wash basins, sinks, bathtubs, showers and other sites for the removal of water of a preferred temperature range.

While specific embodiments ofthe invention have been described in detail to illustrate the application of the principles of the invention, it will be understood that the invention may be embodied otherwise without departing from such principles.

1. A process for producing colored streams of fluid for a hot water fitting, in which hot and cold water is supplied in pipelines separated from one another and the supply of the quantity ratios of hot and cold water is controlled such that a certain temperature is produced, the process comprising the steps of:
a. manually opening of the valves for the hot and cold water;
b. flowing of the hot and cold water into a mixing chamber of the fitting;
c. actuating of a pressure switch g when the pressure rises in said mixing chamber due to the water flowing in;
d. switching on of a control block by means of said pressure switch;
e. sensing of the temperature of the water mixed in said mixing chamber and reporting the thus determined signals to said control block;
f. recognizing the determined signals as a certain temperature;
g. classifying the temperature to one or a plurality of defined temperature ranges;
h. assigning a temperature range to a certain luminous color;
I. activating diodes of the luminous colors red, blue or yellow in question, which are arranged in the area of an outflow opening of the fitting;
j. manually adjusting in the case of the temperature-dependent luminous color deviating from the desired temperature;
k. manually closing of the valves for the hot and cold water when water is no longer needed;
l. switching off of said control block by means of said pressure switch because of the decreased water pressure in said mixing chamber.

2. A process for producing colored streams of fluid for a hot water fitting in accordance with claim 1, wherein according to information from a pressure sensor, the fluid is sent to a temperature sensor, at which a different, temperature-dependent, electric signal is produced in each case, which is transmitted into said control block for comparing the water temperature determined with the set value ranges and for activating said light-emitting diodes in question of a certain color radiation.

3. A process for producing colored streams of fluid for a hot water fitting in accordance with claim 1, wherein the primary colors red, yellow and blue are provided for mixing the water in a temperature-dependent, colored appearance, and these primary colors are mixed additively for producing a light in any desired color.

4. A process for producing colored streams of fluid for a hot water fitting in accordance with claim 1, further comprising, switching over from the temperature-dependent luminous colors produced of the stream of fluid to a temperature-independent production of a color play by means of a constant changing of the luminous colors.

5. A device for producing colored streams of fluid for a hot water fitting, from which either a cold, hot or mixed cold and hot water jet can be taken, the device comprising:
a mixing chamber and a flow channel;
a temperature sensor arranged for measuring the temperature of the water located in the hot water fitting
a diode means including at least one of differently colored light-emitting diodes and an RGB-LED,
a printed circuit board, said temperature sensor and said diode means being functionally connected to circuitry supplied with weak current wherein diodes said diode means being functionally connected to said printed circuit board and being and placed in the fluid flow of said flow channel;
a pressure switch functionally connected to a pressure sensor arranged in said mixing chamber, in the interior thereof, for detecting the flow of water;
a control block, to which is supplied weak current by a transformer (14), is provided as circuitry
a conduit leading from said control block to said temperature sensor, which is arranged at the start of the flow channel in said mixing chamber, said control block being functionally connected both to said pressure switch and to said printed circuit board equipped with said light-emitting diodes, said printed circuit board with said light-emitting diodes having sufficient free space for water flow, and thus, the water is sent to said light-emitting diodes, whereby the colored light rays disperse in said water and a visible color effect is achieved in reflection on the edge of said water or impacting on an obstacle.

6. A device in accordance with claim 5, wherein the colors of said light-emitting diode means are arranged and switched in the necessary number and the selected colors on said printed circuit board, such that a colored jet image, whose action is intended, is produced in the stream of fluid.

7. A device in accordance with claim 5, wherein for mixing the water in a temperature-dependent, colored appearance, said light emitting diode means comprises a red-illuminating diode provided for the primary color red, a yellow-illuminating diode provided for yellow, and a blue-illuminating diode provided for blue, and said control block activating said light-emitting diodes, such that these primary colors are additively mixed for producing a light in any desired color.

8. A device for producing colored streams of fluid for a water fitting, the device comprising:
a mixing chamber connected to a hot water source and a cold water source;
a flow channel connected to said mixing chamber, said flow channel having a mixed hot and cold water outlet;
a temperature sensor for sensing a temperature of a mixed hot and cold water flow;
at least one of differently colored light-emitting diodes and a Red, Green and Blue and light-emitting diode disposed adjacent to said mixed hot and cold water outlet;
power circuitry for supplying a current;
a circuit board, said temperature sensor, said at least one of differently colored light-emitting diodes and said Red, Green and Blue and light-emitting diode being functionally connected to said power circuitry, said at least one of differently colored light-emitting diodes and said Red, Green and Blue and light-emitting diode being functionally connected to said printed circuit board;
a pressure switch functionally connected to a pressure sensor arranged in said mixing chamber for detecting the flow of water; and
a control block connected to said power circuitry, said control block being operatively connected to said temperature sensor and to both said pressure switch and to said printed circuit board.

9. A device in accordance with claim 8, wherein the colors of said light-emitting diodes or said Red, Green and Blue and light-emitting diode are arranged and switched in the necessary number and the selected colors on said printed circuit board such that a colored jet image, whose action is intended, is produced in the stream of fluid.

10. A device in accordance with claim 8, wherein for mixing the water in a temperature-dependent, colored appearance, said light emitting diodes comprise a red-illuminating diode a yellow-illuminating diode and a blue-illuminating diode and said control block activates said light-emitting diodes such that colors are additively mixed for producing a light in a desired color.

11. A device in accordance with claim 8, further comprising an outlet end device, said at least one of differently colored light-emitting diodes and said Red, Green and Blue and light-emitting diode being connected to said circuit board, said circuit board being positioned in said flow channel inwardly of said outlet end device.
